(19) United States
(12) Patent Application Publication
(10) Pub. No.: US 2026/0222973 A1
(43) Pub. Date: Jul. 30, 2026

(54) MESSAGE MONITORING IN ENERGY SAVING NETWORK

(71) Applicant: LENOVO (BEIJING) LIMITED, Beijing (CN)

(72) Inventors: Ran Yue, Beijing (CN); Lianhai Wu, Beijing (CN); Jing Han, Beijing (CN); Jie Hu, Beijing (CN)

(21) Appl. No.: 19/148,732

(22) PCT Filed: Jan. 18, 2023
(86) PCT No.: PCT/CN2023/072950

§ 371 Date: Jul. 17, 2025

(51) Int. Cl. H04W 48/12; H04W 68/00

(52) U.S. Cl. CPC H04W 48/12; H04W 68/00

(57) ABSTRACT

Methods and apparatuses for monitoring a message in a time duration to receive the message in an energy saving network are disclosed. In one embodiment, a UE comprises a processor; and a transceiver coupled to the processor, wherein, the UE supports network energy saving (NES), and the processor is configured to receive, via the transceiver, from an anchor cell, first information to access non-anchor cell(s); and receive, via the transceiver, a message of paging to access a non-anchor cell and/or the anchor cell, system information (SI) change indication or changed SI.

### FIELD

The subject matter disclosed herein generally relates to wireless communications, and more particularly relates to methods and apparatuses for monitoring a message in a time duration to receive the message in an energy saving network.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), master information block (MIB), synchronization signal block (SSB), system information block (SIB), paging occasion (PO), network energy saving (NES), system information (SI), SS/PBCH Block Measurement Time Configuration (SMTC), Master Cell group (MCG), Secondary Cell group (SCG), Primary Cell (PCell), Secondary Cell (SCell), Primary Secondary Cell (PSCell), Random Access Channel (RACH), carrier aggregation (CA), downlink control indicator (DCI), medium access control (MAC), control element (CE), Discontinous Reception (DRX), tracking area (TA), RAN area (RNA), Authentication Management Function (AMF).

It was agreed that UE can camp on an anchor cell. When the UE camps on the anchor cell, the UE can access a non-anchor cell (e.g., NES cell) by receiving system information (SIB or SSB and SIB) of the non-anchor cell from the anchor cell on which it camps.

When the UE accesses the non-anchor cell, if the system information (SI) of the non-anchor cell changes or updates (i.e., SI change), it is not clear how the UE receives the SI change indication.

In addition, when UE camps on an anchor cell, the UE can receive paging message on paging occasion (PO) of the UE on the anchor cell. If the network desires configuring the UE to access the non-anchor cell, how can the UE receive the paging message for that purpose?

This invention targets the above issues.

### BRIEF SUMMARY

Methods and apparatuses for monitoring a message in a time duration to receive the message in an energy saving network are disclosed.

In one embodiment, a UE comprises a processor; and a transceiver coupled to the processor, wherein, the UE supports network energy saving (NES), and the processor is configured to receive, via the transceiver, from an anchor cell, first information to access non-anchor cell(s); and receive, via the transceiver, a message of paging to access a non-anchor cell and/or the anchor cell, system information (SI) change indication or changed SI.

In some embodiment, the UE connects to a first non-anchor cell that is one of the non-anchor cell(s), the message is a system information (SI) change indication associated with the first non-anchor cell, or changed system information associated with the first non-anchor cell, and the message is received from the first non-anchor cell. The processor may be configured to receive, via the transceiver, the message in a DCI or a MAC CE or a RRC signaling or a paging message or a short message.

In some embodiment, the UE connects to a first non-anchor cell that is one of the non-anchor cell(s), the message is a system information change indication associated with the first non-anchor cell, and the processor is configured to monitor, via the transceiver, in the POs from the anchor cell to receive the message.

In some embodiment, the UE camps on the anchor cell, the message is a system information change indication, or a paging message, and the processor is configured to monitor, via the transceiver, in POs from the anchor cell to receive the message. The processor may be configured to monitor, via the transceiver, in POs of the anchor cell for the UE. The message further include at least one of a first indication that indicates the cell for accessing, a second indication that indicates whether the UE is allowed to prioritize non-anchor cells to access, and a third indication that indicates whether the UE is allowed to access non-anchor cells. The processor may be alternatively configured to monitor, via the transceiver, in POs associated with the UE and at least one of the anchor cell and the non-anchor cell(s) to receive the message in a PO associated with the UE and a second non-anchor. The message may be the system information change indication associated with the second non-anchor cell. Alternatively, the message is a paging message, and the processor is further configured to access the second non-anchor cell.

In some embodiment, the processor is further configured to store a configuration of the anchor cell.

In some embodiment, the message is received in a time duration, and the processor is further configured to receive, via the transceiver, a configuration or indication of the time duration, or calculate the time duration based on broadcasted information. The configuration may be a measurement gap or SMTC or a specific duration. The broadcasted information may include at least one of PO configuration of the anchor cell, system information of the anchor cell, and common downlink parameters of a cell.

In another embodiment, a method performed by a UE that supports network energy saving (NES) comprises receiving, from an anchor cell, first information to access non-anchor cell(s); and receiving a message of paging to access a non-anchor cell and/or the anchor cell, system information (SI) change indication or changed SI.

In still another embodiment, a first network device comprises a processor; and a transceiver coupled to the processor, wherein, the first network device manages an anchor cell that manages system information of a UE that supports NES, and the processor is configured to transmit, via the transceiver, a paging related configuration that determines a time duration in which the UE monitors a message of paging to access a non-anchor cell and/or the anchor cell, system information (SI) change indication or changed SI.

In some embodiment, the processor is further configured to receive, via the transceiver, from a second network device that manages the non-anchor cell, a request for the paging related configuration, and the processor is configured to transmit, via the transceiver, to the second network device that manages the non-anchor cell, the paging related configuration upon receiving the request.

In some embodiment, the processor is configured to transmit, via the transceiver, the paging related configuration before the UE transits to connected state.

In yet another embodiment, a method performed by a first network device, wherein, the network device manages an anchor cell that manages system information of a UE that supports NES, and the method comprises transmitting a paging related configuration that determines a time duration in which the UE monitors a message of paging to access a non-anchor cell and/or the anchor cell, system information (SI) change indication or changed SI.

In still another embodiment, a second network device comprises a processor; and a transceiver coupled to the processor, wherein, the second network device manages a non-anchor cell, and the system information of a UE that supports NES is managed by an anchor cell, and the processor is configured to receive, via the transceiver, from a first network device that manages the anchor cell, a paging related configuration that determines a time duration in which the UE monitors a message of paging to access the non-anchor cell and/or the anchor cell, system information (SI) change indication or changed SI.

In some embodiment, the UE connects to the non-anchor cell, the processor is further configured to transmit, via the transceiver, to the network device that manages the anchor cell, a request for the paging related configuration.

In yet another embodiment, a method performed by a second network device that manages a non-anchor cell, wherein, the system information of a UE that supports NES is managed by an anchor cell, and the method comprises receiving, from a first network device that manages the anchor cell, a paging related configuration that determines a time duration in which the UE monitors a message of paging to access the non-anchor cell and/or the anchor cell, system information (SI) change indication or changed SI.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIGS. 1 (a) and 1 (b) illustrate two example scenarios of an anchor cell and two NES cells;

FIG. 2 is a schematic flow chart diagram illustrating an embodiment of a method;

FIG. 3 is a schematic flow chart diagram illustrating a further embodiment of a method;

FIG. 4 is a schematic flow chart diagram illustrating another embodiment of a method; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

NES UE can be also referred to a NES capable UE, or a UE that supports NES technologies, or a UE with the capability to support NES technologies.

An anchor cell is a cell where UE assumes that the cell transmits SSB, system information and paging. A non-anchor cell is a cell that at least does not transmit system information (SI). In particular, a non-anchor cell is a cell that neither transmits SSB nor transmits SIBs, or a cell that transmits SSB but does not transmit SIB(s) (which can be referred to as SIB-less cell).

A NES cell is a cell that supports NES technologies.

Although an anchor cell can be a NES cell, in this disclosure, it is assumed that a NES cell is an example of non-anchor cell.

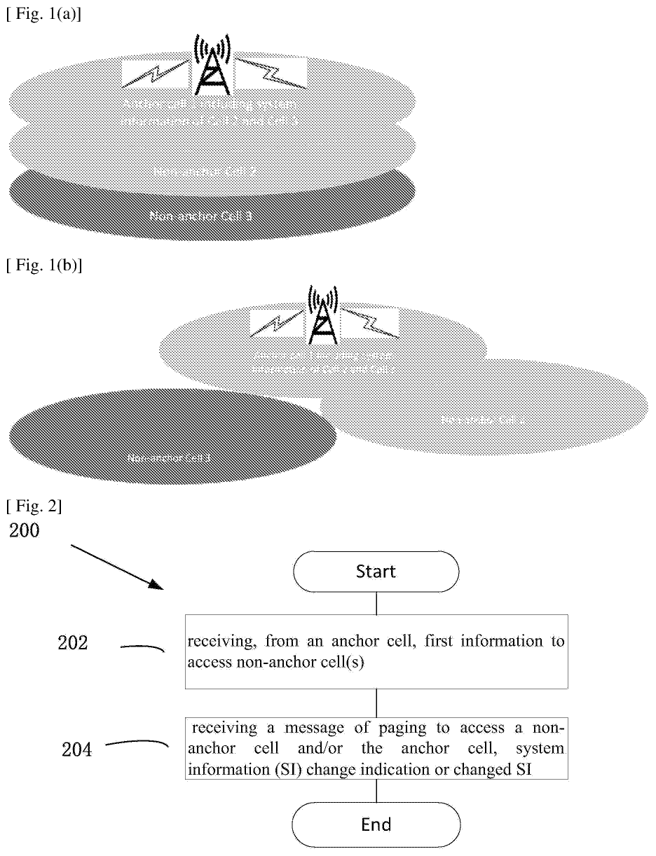

FIGS. 1 (a) and 1 (b) illustrate two example scenarios of an anchor cell and two non-anchor cells. In both FIGS. 1 (a) and 1 (b), cell 1 is the anchor cell. Cell 1 transmits the system information of cell 2 and cell 3. Each of cell 2 and cell 3 is a non-anchor cell. In FIG. 1 (a), anchor cell 1 has the same coverage as each of non-anchor cell 2 and non-anchor cell 3. In FIG. 1 (b), each of anchor cell 1, non-anchor cell 2 and non-anchor cell 3 has a different coverage. UE may access the non-anchor cell (e.g., non-anchor cell 2 or non-anchor cell 3).

A first embodiment relates to receiving system information (SI) change indication.

When the UE (e.g., in RRC_IDLE state or RRC_INACTIVE state) camps on an anchor cell and receives necessary information for accessing non-anchor cell(s), the system information (SI) of the non-anchor cell(s) may change. After the UE accesses a non-anchor cell (e.g., the RRC connection is established between the UE and the non-anchor cell) based on the necessary information for accessing the non-anchor cell received from the anchor cell, the system information (SI) of the non-anchor cell may change. The UE needs to obtain the changed system information of the non-anchor cell. The UE may receive an SI change indication, which indicates that the changed system information (or updated system information) of the non-anchor cell will be transmitted.

The UE camps on the anchor cell or may access the non-anchor cell. So, it is possible for the UE to receive the SI change indication from the anchor cell or the non-anchor cell.

A first sub-embodiment of the first embodiment relates to receiving SI change indication from the anchor cell.

The first sub-embodiment applies to both UE in non-connected state (e.g., in RRC_IDLE state or RRC_INACTIVE state) and UE in connected state (e.g., in RRC_CONNECTED state).

The UE in non-connected state camps on an anchor cell, which means that the UE has received the system information of the anchor cell.

The UE in connected state accesses a non-anchor cell. It means that the UE has received the necessary information for accessing the non-anchor cell from an anchor cell. Accordingly, the UE has received the system information of the anchor cell.

As a whole, the UE, either in non-connected state or in connected state, has received the system information of the anchor cell.

The paging occasion (PO) related parameters or PO related configuration of the anchor cell can be obtained by the UE and the POs associated with the anchor cell can be calculated by the UE according to information including the broadcasted information of the anchor cell. Incidentally, the calculation itself can be made by an existing method. The information of the anchor cell may include the PO configuration of the anchor cell, system information of the anchor cell, common downlink parameters of a cell, etc. The UE stores the information of the anchor cell. It means that the information of the anchor cell (e.g., the PO configuration of the anchor cell) can be used in future. The paging occasion (PO) related parameters or PO related configuration of the non-anchor cell can be obtained by the UE and the POs associated with the non-anchor cell can be calculated by the UE according to information including the broadcasted information of the non-anchor cell. Incidentally, the calculation itself can be made by an existing method.

The UE receives the message related to the non-anchor cell (e.g., SI change indication of the non-anchor cell) from the anchor cell, e.g., in a PO of the anchor cell for the UE. It means that the UE, based on the PO related parameters or configuration of the anchor cell, calculates the POs of the anchor cell and monitors the SI change indication in POs of the anchor cell. Incidentally, the expression “monitor a message in a PO” can also be described as “monitor a PO for a message” (or shortened as “monitor a PO”) or “monitor for a message in a PO”. If the UE is in connected state (e.g., an RRC connection has been established between the UE and the non-anchor cell), the UE monitors SI change indication (including but not being limited to the SI change indication for the UE) in any PO at least once per modification period or the UE monitors SI change indication (including but not being limited to the SI change indication for the UE) in the PO for the UE. If the UE is in non-connected state (e.g., the UE camping on the anchor cell), the UE monitors the SI change indication for the UE (e.g., the SI change indication of the non-anchor cell(s) for the UE where the UE receives at least the necessary information for accessing the non-anchor cell(s)) in the PO for the UE in every DRX cycle or in any PO at least once per modification period.

If the UE in connected state connects to the non-anchor cell, during a time duration (e.g., the POs of the anchor cell for the UE), in which the UE monitors a message (e.g., SI change indication), the UE is unable to perform reception and/or transmission on the non-anchor cell if the UE is not capable to simultaneously receive or transmit on the anchor cell and non-anchor cell. It means that if the UE is not capable to simultaneously receive or transmit on the anchor cell and non-anchor cell, the time duration shall be configured.

The time duration can be up to UE implementation or is scheduled or indicated.

For example, if measurement gap or SMTC (SS/PBCH Block Measurement Time Configuration), which may be configured to the UE by a signaling (e.g., RRC signaling or MAC CE or DCI), is configured and can cover the time duration, the UE can use the measurement gap or the SMTC as the time duration in which the message (e.g., SI change indication) is monitored.

The time duration can be determined by the PO configuration of the anchor cell (for the UE) and other related information. For example, from the perspective of cell (e.g., a non-anchor cell), multiple UEs accessing the non-anchor cell may receive system information of the non-anchor cell from different anchor cells. So, these different anchor cells may broadcast the system information of the non-anchor cell in different cycles or occasions. The difference among different cycles or occasions may affect the time duration for the UE, and can be regarded as other related information for determining the time duration.

Two options are proposed to monitor the message on the anchor cell in the time duration.

In a first option, it is up to network implementation to ensure that the UE (if the UE is not capable to simultaneously receive or transmit on the anchor cell and non-anchor cell) is not scheduled on the non-anchor cell during the time duration in which the UE monitors the message on the anchor cell for the UE.

In a second option, the time duration can be configured to the UE, so that the UE can monitor the message in POs on the anchor cell in the configured time period to receive the message (if the UE is not capable to simultaneously receive or transmit on the anchor cell and non-anchor cell). It means that the UE can use the time period to monitor the message in the POs of the anchor cell for the UE to receive the message.

Since the UE in connected state connects to the non-anchor cell, the time duration can be configured to the UE from the non-anchor cell, for example, by a time duration configuration.

Since the time duration is determined by PO configuration of the anchor cell and other related information that are from the anchor cell, the time duration configuration can be alternatively sent from the anchor cell (which manages or transmits the system information of the non-anchor cell for the UE) to the non-anchor cell (to which the UE connects).

The time duration configuration can be broadcasted from the anchor cell (in particular, the gNB that manages the anchor cell). Each of non-anchor cells (in particular, the gNB that manages the non-anchor cell) that the UE may later access receives the time duration configuration. It means that when the time duration configuration is transmitted (e.g., broadcasted), the UE is in non-connected state, i.e., has not transited to connected state. If a UE that receives, from an anchor cell, necessary information for accessing a non-anchor cell accesses the non-anchor cell that receives the time duration configuration (that is, the UE transits to connected state), the non-anchor cell applies the time duration configuration received from the anchor cell to the UE (that is, knows the time duration (e.g., POs) in which the UE monitors the message on the anchor cell).

Alternatively, the non-anchor cell can request for related configuration e.g., the time duration configuration and/or the periodicity configuration of the message from the anchor cell. And the related information e.g., the time duration configuration and/or the periodicity configuration of the message can be responded by the anchor cell.

Incidentally, the gNB that manages the non-anchor cell and the gNB that manages the anchor cell may be the same gNB or different gNBs. If the gNB that manages the non-anchor cell and the gNB that manages the anchor cell are the same gNB (i.e., the non-anchor cell and the anchor cell are intra-gNB cells), the communication between the non-anchor cell and the anchor cell can be transmitted via the intra-gNB interfaces or interacted internally.

In the first sub-embodiment, if the anchor cell, from which the necessary information for accessing the non-anchor cell that is configured as the PCell (in MCG) or PSCell (in SCG) of the UE, is configured as SCell or a cell in SCG, if the anchor cell is deactivated, it is assumed that the message (e.g., paging message or short message) associated with the UE transmitted in POs of the anchor cell is still transmitted and can be received by the UE on the deactivated cell. Similarly, if the SCG including the anchor cell is deactivated, the message (e.g., paging message or short message) associated with the UE transmitted in POs of the anchor cell is still transmitted and can be received by the UE on the deactivated cell or deactivated SCG.

MCG stands for Master Cell group, while SCG stands for Secondary Cell group. MCG and SCG can be regarded as concepts in dual connectivity. For simplicity, the group that includes the cell to which the UE initiates RACH is MCG, while the group that does not include the cell to which the UE initiates RACH is SCG. If no dual connectivity is configured, there is only one group of cells, which can also be understood as MCG. MCG includes multiple cells, in which the cell for initial access in MCG is referred to as PCell (Primary Cell), while the other cell(s) in MCG are referred to as SCell(s) (Secondary Cell). The PCell and the SCell(s) in MCG can be combined by carrier aggregation (CA). SCG includes multiple cells, in which the cell for initial access in SCG is referred to as PSCell (Primary Secondary Cell), while the other cell(s) in SCG are also referred to as SCell(s). The PSCell and the SCell(s) in SCG can also be combined by CA.

A second sub-embodiment of the first embodiment relates to receiving SI change indication from the non-anchor cell.

The UE in connected state connects to the non-anchor cell. So, it is possible that the UE receives system information related information of the non-anchor cell from the non-anchor cell.

The system information related information may include SI change indication, updated system information, updated SSB, SSB, etc. If the UE receives SI change indication from the non-anchor cell, the UE knows that the SI change indication is for the non-anchor cell. In addition, the UE knows that the updated (or changed) system information of the non-anchor cell will be received, e.g., from the non-anchor cell, or still from the anchor cell.

The system information related information can be indicated at layer 1 (e.g., by a DCI), at layer 2 (e.g., by a MAC CE), or at layer 3 (e.g., by RRC signaling).

Alternatively, the system information related information can be indicated (broadcasted, e.g., by short message) in a periodical manner (similar to legacy PO configuration).

A time duration (similar to paging occasion) during which the UE is possible to receive the system information related information on the non-anchor cell or the paging occasion associated with the non-anchor cell can be configured or indicated to the UE or the paging occasion associated with the non-anchor cell is calculated by the UE according to the related parameter or configuration. It means that the UE monitors the system information related information in the configured or indicated time duration.

An indication that indicates the system information related information (of a non-anchor cell) being transmitted to UE (that accesses the non-anchor cell) may be communicated between the non-anchor cell and the anchor cell (that manages the system information of the non-anchor cell), and particularly between the gNB that manages the non-anchor cell and the gNB that manages the anchor cell. For a first example, the non-anchor cell may indicate to the anchor cell that the system information related information is transmitted to the UE from the non-anchor cell. For a second example, the anchor cell may instruct the non-anchor cell that the system information related information shall be transmitted to the UE from the non-anchor cell.

Incidentally, the gNB that manages the non-anchor cell and the gNB that manages the anchor cell may be the same gNB or different gNBs.

In the second sub-embodiment, similar to the first sub-embodiment, if the anchor cell, from which the necessary information for accessing the non-anchor cell that is configured as the PCell (in MCG) or PSCell (in SCG) of the UE, is configured as SCell or a cell in SCG, if the anchor cell is deactivated, it is assumed that the message (e.g., paging message or short message) associated with the UE transmitted in POs of the anchor cell is still transmitted and can be received by the UE on the deactivated cell. Similarly, if the SCG including the anchor cell is deactivated, the message (e.g., paging message or short message) associated with the UE transmitted in POs of the anchor cell is still transmitted and can be received by the UE on the deactivated cell or deactivated SCG.

A second embodiment relates to the detailed implementations of the UE monitoring a paging notification in the POs of the anchor cell.

As described in the first sub-embodiment of the first embodiment, UE has received the information of the anchor cell, which may include the PO related parameters or PO related configuration of the anchor cell. It means that the UE can monitor a paging notification (e.g., paging message, or SI change indication) in the POs of the anchor cell, e.g., the POs of the anchor cell for the UE.

A UE need not to monitor paging channels continuously. Paging DRX is defined where the UE (e.g., the UE in RRC_IDLE state or RRC_INACTIVE state) is only required to monitor paging channels during one PO per DRX cycle (see TS 38.304). The paging DRX cycles are configured by the network.

The POs of a UE are based on UE ID. The number of different POs in a DRX cycle is configurable via system information. It means that the network may distribute UEs to those POs based on their UE IDs. Although different UEs may be associated with the same PO, from the point of view of the UE, each UE is associated with one PO of the anchor cell in each DRX cycle. In other words, each UE is associated with POs of the anchor cell for the UE.

The SI change indication can be a kind of paging message. It means that, by setting different value(s) in a paging message, the paging message can be implemented as the SI change indication. The SI change indication may alternatively be transmitted via another message that can be monitored in the POs. In other words, when the UE monitors in POs of the anchor cell for the UE, the UE may receive a paging message for the UE or the SI change indication for the UE. In the following description of the second embodiment, the paging message and the SI change indication are collectively referred to as paging notification, which can be received by monitoring in the POs of the anchor cell.

According to a first sub-embodiment of the second embodiment, a UE monitors the paging notification in the POs of the anchor cell for the UE (i.e., based on its UE ID) based the PO configuration of the anchor cell.

If the UE is in connected state, the UE connects to a particular non-anchor cell. So, the SI change indication for the UE is the SI change indication for the particular non-anchor cell.

If the UE is in non-connected state, the UE may have received necessary information for non-anchor cell(s). So, the SI change indication for the UE may mean the system information change of any of the non-anchor cell(s).

Upon receiving the SI change indication from the anchor cell, the UE knows that the updated (or changed) system information of the non-anchor cell(s) will be received, e.g., from the anchor cell.

There may be multiple anchor cells broadcasting the system information for one non-anchor cell. The multiple anchor cells broadcasting the system information for one non-anchor cell shall be within the same TA or within the same RNA. A RAN area (RNA) consists of a group of cells. A tracking area (TA) consists of one or more RNAs. If the multiple anchor cells broadcasting the system information for the non-anchor cell are not within the same TA, the TA shall be updated to include the multiple anchor cells.

According to the first sub-embodiment of the second embodiment, the SI change indication only indicates that the updated (or changed) system information of the non-anchor cell(s) will be received. It means that the UE is not required to determine the cell for accessing based on the received SI change indication. Instead, the UE can determine any non-anchor cell as the cell for accessing by other conditions, e.g., based on cell selection criteria and/or cell reselection criteria.

According to a second sub-embodiment of the second embodiment, a UE monitors the paging notification in the POs of the anchor cell for the UE (i.e., based on its UE ID) based the PO configuration of the anchor cell (i.e., the same as the first sub-embodiment of the second embodiment).

According to the second sub-embodiment, the paging notification is enhanced. It means that the enhanced indication (e.g., the enhanced SI change indication, or the enhanced paging message implemented as the enhanced SI change indication) includes extra indications, where the extra indications may include but not be limited to at least one of: a first indication that indicates the cell (the anchor cell, or any non-anchor cell that the necessary information for accessing the non-anchor cell is received by the UE) for accessing, a second indication that indicates whether the UE is allowed to prioritize non-anchor cells to access (which means that the UE prefer determining an non-anchor cell as the cell for accessing than determining the anchor cell as the cell for accessing), and a third indication that indicates whether the UE is allowed to access non-anchor cells. The extra indications may be useful for the UE in non-connected state to determine the cell for accessing from the non-anchor cells.

The enhanced indication can be determined by the core network (e.g., AMF) or by the RAN node (e.g., gNB).

For example, if the AMF knows that a cell is a non-anchor cell, the AMF may instruct the gNB that manages the anchor cell to send enhanced indication in the POs of the anchor cell for the UE that connects to the non-anchor cell.

For another example, if the AMF does not know that a cell is non-anchor cell, the AMF may page the UE on cells including the non-anchor cell. The gNB that manages the non-anchor cell will send the paging instruction to the gNB that manages the anchor cell. Either the gNB that manages the non-anchor cell or the gNB that manages the anchor cell can determine to page the UE with the enhanced indication.

The gNB that manages the non-anchor cell and the gNB that manages the anchor cell may be the same gNB or different gNBs. If the gNB that manages the non-anchor cell and the gNB that manages the anchor cell are the same gNB (i.e., the non-anchor cell and the anchor cell are intra-gNB cells), the communication between the non-anchor cell and the anchor cell can be transmitted via the intra-gNB interfaces or interacted internally.

According to a third sub-embodiment of the second embodiment, the PO configuration (i.e., the PO configuration of the anchor cell) is enhanced. In legacy, the network distributes UEs to POs based on their UE IDs based on the PO configuration. It means that, from the UE point of view, each UE is associated with POs of the anchor cell for the UE.

In the enhanced PO configuration according to the third sub-embodiment, each UE with each cell is associated with POs of the anchor cell for the UE and the cell. For example, a UE is associated with an anchor cell #1 on which it camps (the UE receives the system information of non-anchor cells (e.g., non-anchor cell #2 and non-anchor cell #3)), non-anchor cell #2, and non-anchor cell #3. The UE in non-connected state (e.g., in RRC_IDLE or RRC_INACTIVE state) may be possible to access one of the non-anchor cells when necessary. The UE in connected state (e.g., in RRC_CONNECTED state) connects to one of the non-anchor cells.

The third sub-embodiment mainly aims at the UE in non-connected state.

The UE with anchor cell #1 is associated with POs of the anchor cell for the UE and cell #1; the UE with non-anchor cell #2 is associated with POs of the anchor cell for the UE and cell #2; and the UE with non-anchor cell #3 is associated with POs of the anchor cell for the UE and cell #3.

Based on the enhanced PO configuration, the UE may monitor the paging notification in the POs from the anchor cell for the UE (e.g., monitors in the POs associated with the UE and cell #1, the POs associated with the UE and cell #2, and the POs associated with the UE and cell #3). It means that if the UE receives a paging notification, the UE knows, according to the PO in which the paging notification is received, that the paging notification is for which cell. For example, if the paging notification is an SI change indication received in a PO associated with the UE and cell #2, the UE knows that the SI change indication of the non-anchor cell #2 is received. For another example, the paging message can be regarded as an indication to instruct the UE to access the cell. For example, when the indication to instruct the UE to access the cell is received in a PO associated with the UE and cell #2, the UE determines the non-anchor cell #2 as the cell for accessing, and accordingly, the UE accesses the non-anchor cell #2.

Optionally, the UE may not monitor the paging notification in the POs associated with the UE and the anchor cell. For example, the UE does not monitor in the POs associated with the UE and cell #1.

Further optionally, the UE may only monitor the paging notification in the POs associated with the UE and predetermined non-anchor cell(s). The predetermined non-anchor cell(s) may be determined by the UE, based on other condition(s). For example, the predetermined non-anchor cell(s) can be: the cell for accessing or candidate cells for accessing; or best cell(s) (e.g., the quality (ies) of the predetermined non-anchor cell(s) are the best quality (ies)). For example, if the UE determines that non-anchor cell #2 is the predetermined non-anchor cell, the UE may only monitor the paging notification in the POs associated with the UE and cell #2. If the paging message is received in a PO associated with the UE and cell #2, the UE determines the non-anchor cell #2 as the cell for accessing, and accesses the non-anchor cell #2.

FIG. 2 is a schematic flow chart diagram illustrating an embodiment of a method 200 according to the present application. In some embodiments, the method 200 is performed by an apparatus, such as a remote unit (UE). In certain embodiments, the method 200 may be performed by a processor executing program code, for example, a microcontroller, a microprocessor, a CPU, a GPU, an auxiliary processing unit, a FPGA, or the like.

The method 200 may be performed by a UE that supports network energy saving (NES), the method comprises 202 receiving, from an anchor cell, first information to access non-anchor cell(s); and 204 receiving a message of paging to access a non-anchor cell and/or the anchor cell, system information (SI) change indication or changed SI.

In some embodiment, the UE connects to a first non-anchor cell that is one of the non-anchor cell(s), the message is a system information (SI) change indication associated with the first non-anchor cell, or changed system information associated with the first non-anchor cell, and the message is received from the first non-anchor cell. The method may comprise receiving the message in a DCI or a MAC CE or a RRC signaling or a paging message or a short message.

In some embodiment, the UE connects to a first non-anchor cell that is one of the non-anchor cell(s), the message is a system information change indication associated with the first non-anchor cell, and the method comprises monitoring in the POs from the anchor cell to receive the message.

In some embodiment, the UE camps on the anchor cell, the message is a system information change indication, or a paging message, and the method comprises monitoring in POs from the anchor cell to receive the message. The method may comprise monitoring in POs of the anchor cell for the UE. The message further include at least one of a first indication that indicates the cell for accessing, a second indication that indicates whether the UE is allowed to prioritize non-anchor cells to access, and a third indication that indicates whether the UE is allowed to access non-anchor cells. The method may alternatively comprise monitoring in POs associated with the UE and at least one of the anchor cell and the non-anchor cell(s) to receive the message in a PO associated with the UE and a second non-anchor. The message may be the system information change indication associated with the second non-anchor cell. Alternatively, the message is a paging message, and the method further comprises accessing the second non-anchor cell.

In some embodiment, the method further comprises storing a configuration of the anchor cell.

In some embodiment, the message is received in a time duration, and the method further comprises receiving a configuration or indication of the time duration, or calculating the time duration based on broadcasted information. The configuration may be a measurement gap or SMTC or a specific duration which can be configured to the UE by a signaling e.g. RRC signaling or MAC CE or DCI. The broadcasted information may include at least one of PO configuration of the anchor cell, system information of the anchor cell, and common downlink parameters of a cell.

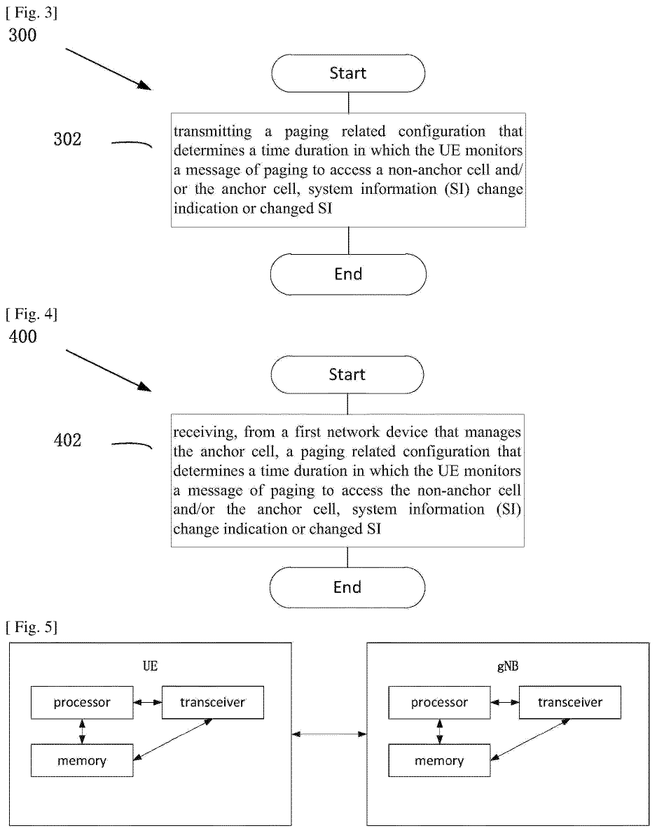

FIG. 3 is a schematic flow chart diagram illustrating a further embodiment of a method 300 according to the present application. In some embodiments, the method 300 is performed by an apparatus, such as a base unit or a network device. In certain embodiments, the method 300 may be performed by a processor executing program code, for example, a microcontroller, a microprocessor, a CPU, a GPU, an auxiliary processing unit, a FPGA, or the like.

The method 300 may be performed by a first network device, wherein, the first network device manages an anchor cell that manages system information of a UE that supports NES, and the method comprises 302 transmitting a paging related configuration that determines a time duration in which the UE monitors a message of paging to access a non-anchor cell and/or the anchor cell, system information (SI) change indication or changed SI.

In some embodiment, the method further comprises receiving, from a second network device that manages the non-anchor cell, a request for the paging related configuration, and transmitting, to the second network device that manages the non-anchor cell, the paging related configuration upon receiving the request.

In some embodiment, the method comprises transmitting the paging related configuration before the UE transits to connected state.

FIG. 4 is a schematic flow chart diagram illustrating a further embodiment of a method 400 according to the present application. In some embodiments, the method 400 is performed by an apparatus, such as a base unit or a network device. In certain embodiments, the method 400 may be performed by a processor executing program code, for example, a microcontroller, a microprocessor, a CPU, a GPU, an auxiliary processing unit, a FPGA, or the like.

The method 400 may be performed by a second network device that manages a non-anchor cell, wherein, the system information of a UE that supports NES is managed by an anchor cell, the method comprises 402 receiving, from a first network device that manages the anchor cell, a paging related configuration that determines a time duration in which the UE monitors a message of paging to access the non-anchor cell and/or the anchor cell, system information (SI) change indication or changed SI.

In some embodiment, the UE connects to the non-anchor cell, and the method further comprises transmitting, to the network device that manages the anchor cell, a request for the paging related configuration.

FIG. 5 is a schematic block diagram illustrating apparatuses according to one embodiment.

Referring to FIG. 5, the UE (i.e., remote unit, or terminal device) includes a processor, a memory, and a transceiver. The processor implements a function, a process, and/or a method which are proposed in FIG. 2.

The UE comprises a processor; and a transceiver coupled to the processor, wherein, the UE supports network energy saving (NES), and the processor is configured to receive, via the transceiver, from an anchor cell, first information to access non-anchor cell(s); and receive, via the transceiver, a message of paging to access a non-anchor cell and/or the anchor cell, system information (SI) change indication or changed SI.

In some embodiment, the UE connects to a first non-anchor cell that is one of the non-anchor cell(s), the message is a system information (SI) change indication associated with the first non-anchor cell, or changed system information associated with the first non-anchor cell, and the message is received from the first non-anchor cell. The processor may be configured to receive, via the transceiver, the message in a DCI or a MAC CE or a RRC signaling or a paging message or a short message.

In some embodiment, the UE connects to a first non-anchor cell that is one of the non-anchor cell(s), the message is a system information change indication associated with the first non-anchor cell, and the processor is configured to monitor, via the transceiver, in the POs from the anchor cell to receive the message.

In some embodiment, the UE camps on the anchor cell, the message is a system information change indication, or a paging message, and the processor is configured to monitor, via the transceiver, in POs from the anchor cell to receive the message. The processor may be configured to monitor, via the transceiver, in POs of the anchor cell for the UE. The message further include at least one of a first indication that indicates the cell for accessing, a second indication that indicates whether the UE is allowed to prioritize non-anchor cells to access, and a third indication that indicates whether the UE is allowed to access non-anchor cells. The processor may be alternatively configured to monitor, via the transceiver, in POs associated with the UE and at least one of the anchor cell and the non-anchor cell(s) to receive the message in a PO associated with the UE and a second non-anchor. The message may be the system information change indication associated with the second non-anchor cell. Alternatively, the message is a paging message, and the processor is further configured to access the second non-anchor cell.

In some embodiment, the processor is further configured to store a configuration of the anchor cell.

In some embodiment, the message is received in a time duration, and the processor is further configured to receive, via the transceiver, a configuration or indication of the time duration, or calculate the time duration based on broadcasted information. The configuration may be a measurement gap or SMTC or a specific duration. The broadcasted information may include at least one of PO configuration of the anchor cell, system information of the anchor cell, and common downlink parameters of a cell.

Referring to FIG. 5, the gNB (i.e., base unit or network device) includes a processor, a memory, and a transceiver. The processor implements a function, a process, and/or a method which are proposed in FIG. 3 or 4.

A first network device comprises a processor; and a transceiver coupled to the processor, wherein, the first network device manages an anchor cell that manages system information of a UE that supports NES, and the processor is configured to transmit, via the transceiver, a paging related configuration that determines a time duration in which the UE monitors a message of paging to access a non-anchor cell and/or the anchor cell, system information (SI) change indication or changed SI.

In some embodiment, the processor is further configured to receive, via the transceiver, from a second network device that manages the non-anchor cell, a request for the paging related configuration, and the processor is configured to transmit, via the transceiver, to the second network device that manages the non-anchor cell, the paging related configuration upon receiving the request.

In some embodiment, the processor is configured to transmit, via the transceiver, the paging related configuration before the UE transits to connected state.

A second network device comprises a processor; and a transceiver coupled to the processor, wherein, the second network device manages a non-anchor cell, and the system information of a UE that supports NES is managed by an anchor cell, and the processor is configured to receive, via the transceiver, from a first network device that manages the anchor cell, a paging related configuration that determines a time duration in which the UE monitors a message of paging to access the non-anchor cell and/or the anchor cell, system information (SI) change indication or changed SI.

In some embodiment, the UE connects to the non-anchor cell, the processor is further configured to transmit, via the transceiver, to the network device that manages the anchor cell, a request for the paging related configuration.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) that supports network energy saving, the UE comprising:
at least one memory; and
at least one processor coupled with the at least one memory and configured to cause the UE to:
receive from an anchor cell, first information to access non-anchor cell(s); and
receive a message of paging to access a non-anchor cell and/or the anchor cell, system information (SI) change indication or changed SI.

2. The UE of claim 1, wherein the UE connects to a first non-anchor cell that is one of the non-anchor cell(s), the message is a SI change indication associated with the first non-anchor cell, or changed system information associated with the first non-anchor cell, and the message is received from the first non-anchor cell.

3. The UE of claim 2, wherein the at least one processor is configured to cause the UE to receive the message in a downlink control information (DCI), a medium access control control element (MAC CE), a radio resource control (RRC) signaling, a paging message, or a short message.

4. The UE of claim 1, wherein the UE connects to a first non-anchor cell that is one of the non-anchor cell(s), the message is a SI change indication associated with the first non-anchor cell, and the at least one processor is configured to cause the UE to monitor paging occasions (POs) from the anchor cell to receive the message.

5. The UE of claim 1, wherein the UE camps on the anchor cell,
the message is a SI change indication, or a paging message, and the at least one processor is configured to cause the UE to monitor paging occasions (POs) from the anchor cell to receive the message.

6. The UE of claim 5, wherein the at least one processor is configured to cause the UE to monitor paging occasions (POs) of the anchor cell for the UE.

7. The UE of claim 6, wherein the message further includes at least one of:
a first indication that indicates the cell for accessing:
a second indication that indicates whether the UE is allowed to prioritize non-anchor cells to access; and
a third indication that indicates whether the UE is allowed to access non-anchor cells.

8. The UE of claim 5, wherein the at least one processor is configured to cause the UE to monitor paging occasions (POs) associated with the UE and at least one of the anchor cell and the non-anchor cell(s) to receive the message in a PO associated with the UE and a second non-anchor cell.

9. The UE of claim 8, wherein the message is the SI change indication associated with the second non-anchor cell.

10. The UE of claim 8, wherein the message is a paging message, and the at least one processor is configured to cause the UE to access the second non-anchor cell.

11. The UE of claim 1, wherein the message is received in a time duration, and the at least one processor is configured to cause the UE to receive a configuration or indication of the time duration, or calculate the time duration based on broadcasted information.

12. A first network device that manages an anchor cell that manages system information (SI) of a user equipment (UE) that supports network energy savings (NES), the first network device comprising:
at least one memory; and
at least one processor coupled with the at least one memory and configured to cause the first network device to:
transmit a paging related configuration that determines a time duration in which the UE monitors a message of paging to access a non-anchor cell and/or the anchor cell, SI change indication or changed SI.

13. The first network device of claim 12, wherein the at least one processor is configured to cause the first network device to:
receive from a second network device that manages the non-anchor cell, a request for the paging related configuration, and
transmit to the second network device that manages the non-anchor cell, the paging related configuration upon receiving the request.

14. A second network device that manages a non-anchor cell and the system information (SI) of a user equipment (UE) that supports network energy savings (NES) that is managed by an anchor cell, the second network device comprising:
at least one memory; and
at least one processor coupled with the at least one memory and configured to cause the second network device to:
receive from a first network device that manages the anchor cell, a paging related configuration that determines a time duration in which the UE monitors a message of paging to access the non-anchor cell and/or the anchor cell, SI change indication or changed SI.

15. The second network device of claim 14, wherein the UE accesses the non-anchor cell, and the at least one processor is configured to cause the second network device to transmit to the network device that manages the anchor cell, a request for the paging related configuration.

16. A processor for wireless communication that supports network energy saving, the processor comprising:
at least one controller coupled with at least one memory and configured to cause the processor to:
receive from an anchor cell, first information to access non-anchor cell(s); and
receive a message of paging to access a non-anchor cell and/or the anchor cell, system information (SI) change indication or changed SI.

17. The processor of claim 16, wherein the processor connects to a first non-anchor cell that is one of the non-anchor cell(s), the message is a SI change indication associated with the first non-anchor cell, or changed system information associated with the first non-anchor cell, and the message is received from the first non-anchor cell.

18. The processor of claim 17, wherein the at least one controller is configured to cause the processor to receive the message in downlink control information (DCI), a medium access control control element (MAC CE), a radio resource control (RRC) signaling, a paging message, or a short message.

19. The processor of claim 16, wherein the processor connects to a first non-anchor cell that is one of the non-anchor cell(s), the message is a SI change indication associated with the first non-anchor cell, and the at least one controller is configured to cause the processor to monitor paging occasions (POs) from the anchor cell to receive the message.

20. The processor of claim 16, wherein the processor camps on the anchor cell, the message is a SI change indication, or a paging message, and the at least one controller is configured to cause the processor to monitor paging occasions (POs) from the anchor cell to receive the message.
